(19) United States
(12) Patent Application Publication
(10) Pub. No.: US 2007/0250325 A1
(43) Pub. Date: Oct. 25, 2007

(54) Systems and Methods for Generating An Address List

(76) Inventor: James Christian Currey, El Paso, TX (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/278,355

(22) Filed: Mar. 31, 2006

(51) Int. Cl. G06Q 30/00

(52) U.S. Cl. 705/1

(57) ABSTRACT

Methods and systems consistent with the present invention provide a data processing system having an address list generator. The generator receives a code for a source address that has a zip code portion and either a street address portion, a postal box number, or a rural route number, identifies each address in a plurality of addresses corresponding to the code, and determines whether a subset of more than one address has been identified. If such a subset is identified, the generator determines whether two or more addresses in the subset differ by either a direction precedent, a direction subsequent, a street suffix, or a subunit number. If such a difference is found, the generator prompts for a cue associated with the source address and corresponding to the different direction precedent, direction subsequent, street suffix, or subunit number and identifies a single address from among the subset based on the cue.

### FIELD OF THE INVENTION

The present invention relates to data entry systems and methods and, more particularly, to systems and methods for generating an address list from a plurality of addresses.

### BACKGROUND OF THE INVENTION

Businesses, charitable organizations and governmental authorities frequently require address lists. For example, a business may receive checks from customers for the provision of goods or services. The business decides to have a list prepared of the addresses of these customers so that advertising literature can be sent to them in the future. Similarly, a charity may receive checks from donors. The charity concludes that an address list of these contributors is needed so that a newsletter can be sent to them concerning the organization's activities. Customarily, entities that desire address lists (the “Customer”) typically are not equipped to prepare them. Accordingly, a third party preparer (the “Preparer”) is often hired to produce address lists.

Conventional methods for preparing an address list require the Customer to deliver to the Preparer the documents/checks, or electronic images thereof (the “Original Address Sources) that set forth the addresses that are to be included in an address list. Employees of the Preparer typically enter the addresses identified on the Original Address Sources into a computer program or spreadsheet that organizes the inputted addresses into an address list.

Most Customers want their address lists prepared cheaply, expeditiously and accurately. However, due to relatively high labor costs in the United States and in Western Europe, a Preparer cannot use U.S. or Western European labor and seeks to produce address lists in countries where labor costs are relatively low (e.g., Eastern Europe countries and Mexico). Thus, the Preparer will typically hire individuals from these low-cost labor countries to enter into a computer the addresses set forth on the Original Address Sources so that the computer can organize and store the desired address list. These individuals, however, do not generally speak or read English or any Western European languages. Thus, they are not able to read or understand the addresses on the Original Address Sources that they are required to input into a computer. This inability to read or understand what is being entered makes it difficult for the Preparer to achieve the Customer objective that an address list be produced accurately and expeditiously. In particular, an individual hired for address entry who cannot read or understand what is being typed tends to take additional time to figure out what needs to be entered and often fails to detect erroneous entries that would clearly appear incorrect to a person familiar with the language of the address being inputted.

If existing technology is utilized to prepare an address list, then an operator must manually enter the entire address from an Original Address Source. This takes time and provides ample opportunity for an address to be incorrectly inputted. An erroneous address can arise either because a wrong key has been pressed (e.g., the employee presses an “m” when he or she intended to press an “n”), or because the address to be entered was misread (e.g., the employee thought an address component was “Alton” when it actually was “Acton”).

In view of the foregoing, the Preparer cannot utilize existing technology to achieve the Customer objective that an address list be prepared cheaply, expeditiously and accurately.

The Firstlogic company and the Siemens Dematic company have each developed a system for assigning mailings having a five digit zip code with a nine digit zip code to allow bulk mailers to take advantage of discounts offered by the United States Postal Service for collating mailings by nine digit zip codes. The Firstlogic system and the Siemens Dematic system each require partial manual entry of the address on the mailing in order for the respective system to derive one or more corresponding addresses with a respective nine digit zip code. However, each of these conventional systems requires manual entry steps that result in speed and accuracy inefficiencies.

In particular, the Firstlogic system requires a data entry person to enter the five digit zip code that is on a mailing and then start inputting each character of the address on the mailing including any spaces until the Firstlogic system identifies the entire address including the additional four digits needed to form the corresponding nine digit zip code. Thus, a data entry person for the Firstlogic system is often required to input at least 18 or more characters before an entire address can be identified by the Firstlogic system, especially when the first portion of the street address corresponds to multiples street addresses (e.g., 1300 Desert Canyon Road versus 1300 Desert Jewel Road). Accordingly, a more labor efficient system, requiring fewer manual entry keystrokes than the Firstlogic system, is needed to decrease the production cost of generating an address list for a Customer.

The Siemens Dematic system requires a data entry person to view the address on a mailing and enter a corresponding code to allow the Siemens Dematic system to identify the additional four digits needed to form the nine digit zip code for the mailing and not to identify the entire address. The code required by the Siemens Dematic system consists of: (i) the first three letters of the name of the street set forth on the mailing and (ii) the first letter of the second word that comprises the name of the street on the mailing. For example, assume the mailing in view of the data entry person for the Siemens Dematic system is as follows.
1300 Desert Road
El Paso, Tex. 79912

The Siemens Dematic system would require the data entry person to enter “DESR” for a code. The Siemens Dematic system would then display all the addresses that correspond to the “DESR” code. Frequently the code of the Siemens Dematic system does not yield just one address, resulting in the Siemens Dematic system displaying several addresses on the data entry person's screen. The Siemens Dematic system then requires the data entry person to take the time to read these several addresses and select therefrom the one that is set forth on the mailing currently being processed. This time consuming exercise of scrutinizing addresses by the data entry person not only slows down the identification of the additional four zip code digits but also allows greater opportunity for human error as the data entry person for the Siemens Dematic system may inadvertently or carelessly select an incorrect address thereby resulting in the entry of the wrong four digits by the Siemens Dematic system for the mailing currently being processed.

Therefore, a need has long existed for systems and methods that overcome the problems noted above and others previously experienced for generating an address list quickly and accurately.

### SUMMARY OF THE INVENTION

In accordance with methods consistent with the present invention, a method is provided in a data processing system for generating an address list from among a plurality of addresses. The method comprises receiving an address code for a source address. The address code has a zip code portion and either a street address portion, a postal box number, or a rural route number. The method further comprises identifying each address in the plurality of addresses corresponding to the address code, determining whether a subset of more than one address has been identified; and when it is determined that a subset of more than one address has been identified, determining whether two or more addresses in the subset differ by at least one of a direction precedent, a direction subsequent, a street suffix, and a subunit number. In addition, when it is determined that two or more addresses in the subset differ by at least one of a direction precedent, a direction subsequent, a street suffix, and a subunit number, the method further comprises prompting for a cue associated with the source address and corresponding to the one of the direction precedent, a direction subsequent, a street suffix, and a subunit number; and identifying a single address from among the subset based on the cue.

In addition, in accordance with methods consistent with the present invention, another method is provided in a data processing system for generating an address list from among a plurality of addresses. The method comprises: receiving an address code for a source address where the address code has a zip code portion and either a postal box number or a rural route number; and identifying an address in the plurality of addresses based on the address code.

In accordance with articles of manufacture consistent with the present invention, a computer-readable medium containing instructions to perform a method for generating an address list from among a plurality of addresses is provided. The method comprises: receiving an address code for a source address in which the address code has a zip code portion and either a street address portion, a postal box number, or a rural route number. The method further comprises identifying each address in the plurality of addresses corresponding to the address code; determining whether a subset of more than one address has been identified; and when it is determined that a subset of more than one address has been identified, determining whether two or more addresses in the subset differ by at least one of a direction precedent, a direction subsequent, a street suffix, and a subunit number. The method further comprises, when it is determined that two or more addresses in the subset differ by at least one of a direction precedent, a direction subsequent, a street suffix, and a subunit number, prompting for a cue associated with the source address and corresponding to the at least one of the direction precedent, the direction subsequent, the street suffix, and the subunit number; and identifying a single address from among the subset based on the cue.

In accordance with articles of manufacture consistent with the present invention, a computer-readable medium containing instructions to perform another method for generating an address list from among a plurality of addresses is provided. The method comprises: receiving an address code for a source address in which the address code has a zip code portion and either a postal box number or a rural route number; and identifying an address in the plurality of addresses based on the address code.

In accordance with systems consistent with the present invention, a data processing system is provided. The data processing system includes: a memory device having an address list generator program that receives an address code derived from a source address and having a zip code portion and either a street address portion, a postal box number, or a rural route number. The address list generator further identifies each address in the plurality of addresses corresponding to the address code, determines whether a subset of more than one address has been identified, when it is determined that a subset of more than one address has been identified, determines whether two or more addresses in the subset differ by at least one of a direction precedent, a direction subsequent, a street suffix, and a subunit number. When it is determined that two or more addresses in the subset differ by at least one of a direction precedent, a direction subsequent, a street suffix, and a subunit number, the address list generator program prompts for a cue associated with the source address and corresponding to the at least one of the direction precedent, the direction subsequent, the street suffix, and the subunit number, and identifies a single address from among the subset based on the cue. The data processing system further includes a processor that runs the address list generator program.

In accordance with systems consistent with the present invention, a data processing system is provided that includes a memory device having an address list generator program. The address list generator program receives an address code derived from a source address. The address code has a zip code portion and either a postal box number or a rural route number. The address list generator program further identifies an address in the plurality of addresses based on the address code. The data processing system further includes a processor that runs the address list generator program.

In accordance with systems consistent with the present invention, a data processing system is provided that includes: means for receiving an address code for a source address. The address code has a zip code portion and either a street address portion, a postal box number, or a rural route number. The data processing system further includes means for identifying each address in the plurality of addresses corresponding to the address code; means for determining whether a subset of more than one address has been identified; means for, when it is determined that a subset of more than one address has been identified, determining whether two or more addresses in the subset differ by at least one of a direction precedent, a direction subsequent, a street suffix, and a subunit number; and means for, when it is determined that two or more addresses in the subset differ by at least one of a direction precedent, a direction subsequent, a street suffix, and a subunit number, prompting for a cue associated with the source address and corresponding to the at least one of the direction precedent, the direction subsequent, the street suffix, and the subunit number; and identifying a single address from among the subset based on the cue.

In accordance with systems consistent with the present invention, a data processing system is provided that includes: means for receiving an address code derived from a source address. The address code has a zip code portion and either a postal box number or a rural route number. The data processing system further includes means for identifying an address in the plurality of addresses based on the address code.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts a block diagram of an exemplary data processing system consistent with the present invention;

FIGS. 2A-2D depict a flow diagram illustrating an exemplary process performed by an address list generator of the data processing system in FIG. 1 to identify one of a plurality of addresses for a list based on an address code provided by a user;

FIG. 3 depicts an exemplary user interface displayed by the address list generator to prompt a user to enter an address code corresponding to a source address in accordance with the present invention;

FIG. 4 depicts an exemplary user interface displayed by the address list generator to prompt a user to enter a direction precedent cue corresponding to the source address in accordance with the present invention;

FIG. 5 depicts an exemplary user interface displayed by the address list generator to prompt a user to enter a direction subsequent cue corresponding to the source address in accordance with the present invention;

FIG. 6 depicts an exemplary user interface displayed by the address list generator to prompt a user to enter a subunit number cue corresponding to the source address in accordance with the present invention;

FIG. 7 depicts an exemplary user interface displayed by the address list generator to prompt a user to enter a street suffix cue corresponding to the source address in accordance with the present invention;

FIG. 8 depicts an exemplary user interface displayed by the address list generator to prompt a user to enter an additional street character corresponding to the source address in accordance with the present invention; and

FIG. 9 depicts an exemplary user interface displayed by the address list generator to prompt a user to verify the one identified address from among the plurality of addresses for a list corresponds to the source address in accordance with the present invention.

### DETAILED DESCRIPTION OF THE INVENTION

Reference will now be made in detail to an implementation in accordance with methods, systems, and products consistent with the present invention as illustrated in the accompanying drawings. The same reference numbers may be used throughout the drawings and the following description to refer to the same or like parts.

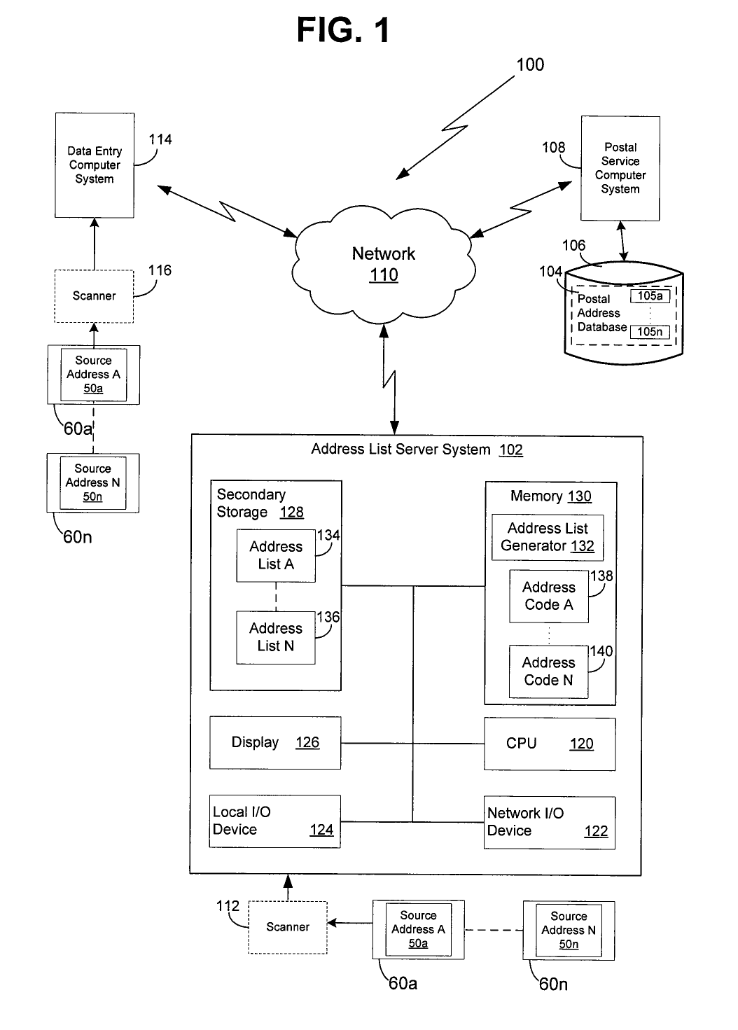

FIG. 1 depicts a block diagram of a data processing system 100 suitable for practicing methods and implementing systems consistent with the present invention. The data processing system 100 includes an address list server system 102 that has stored locally or has access to a postal address database 104 that includes a plurality of addresses 105a-105n; each address 105a-105n is associated with a respective location by a postal service agency. In one implementation, the postal address database 104 corresponds to the database of addresses to which United States Postal Service agency delivers mail. The US Postal Service sells its database of addresses (including periodic updates) to interested parties. Alternatively, the postal address database 104 may correspond to the database of addresses to which a foreign postal service agency, such as in France or Germany, delivers mail.

As shown in the implementation in FIG. 1, the postal address database 104 may be stored on a storage device 106 operatively connected to and controlled by a postal service computer system 108 associated with the postal service agency. In this implementation, the address list server system 102 is operatively connected to the postal service computer system 108 via a network 110 such that the address list server system 102 may access the postal address database 104 across the network 110 via the postal service computer system 108. The network 110 may be any known private or public communication network, such as a local area network (“LAN”), WAN, Peer-to-Peer, or the Internet, using standard communications protocols. The network 110 may include hardwired as well as wireless branches. Alternatively, the postal address database 104 may be downloaded or ported to (e.g., via a removable storage device not shown in the figures) the address list server system 102 for local storage and access.

As discussed in detail below, the address list server system 102 is operatively configured to enable a user to prepare an address list from the plurality of addresses 105a-105n in the postal address database 104 based on a plurality of source addresses 50a-50n identified on a group of source documents 60a-60n, such as mailings (e.g., letters or post cards), checks, receipts, or other item bearing an address of interest to a customer seeking to efficiently and accurately compile a list of the source addresses 50a-50n. The documents 60a-60n may be physical documents or electronic images. In one implementation in which the source documents 60a-60n, the data processing system 100 may include a scanner 112 operatively connected to the address list server system 102. In this implementation, the scanner 112 is operatively configured to convert each of the documents 60a-60n into a corresponding electronic image bearing the respective source address 50a or 50n of the source document 60a or 60n and to transmit the respective electronic image of the source address 50a or 50n to the address list server system 102, either automatically or upon request by the server system 102. The address list server system 102 may be operatively configured to display the electronic image of a source document 60a or 60n bearing a source address 50a or 50n so that the user may then input an address code into the address list server system 102 and the address list server system may identify a corresponding single address or a corresponding subset of addresses from the plurality of addresses 105a-105n stored in the postal service database 104 in accordance with the present invention.

As shown in FIG. 1, the data processing system 100 may also include one or more data entry computer systems 114 operatively connected to the address list server system 102 via the network 110. Each data entry computer system 114 may be operatively connected to a respective scanner 116 for receiving and electronically imaging the source documents 60a-60n bearing the source addresses 50a-50n. In this implementation, each data entry computer system 114 may be operatively configured to receive an address code from a respective user and to transfer the address code to the address list server system 102 for processing in accordance with the present invention for generating a corresponding address list as further discussed below.

The address list server system 102 may be an IBM or Apple compatible computer system or other standard computer system or server. As shown in FIG. 1, address list server system 102 includes a central processing unit or CPU 120, a network I/O device 122 operatively configured to connect the address list server system 102 to the network 110, a local I/O device 124 (which may connect to a keyboard, mouse, or other input device not shown in the figures as well as the scanner 112), a display 126, a secondary storage device 128, and a memory 130. The secondary storage device 128 may be a removable storage device for porting the postal address database 104 to the address list server system 102.

Memory 130 includes an address list generator 132 program used in accordance with systems and methods consistent with the present invention to allow a user to generate an address list 134 or 136 from a plurality of addresses 105a-105n stored in the postal service database 104 based on one or more address codes 138 and 140 derived by the user from the source addresses 50a-50n identified on the source documents 60a-60n. Each address code 138 and 140 may be input by a user using the input device connected to the local I/O device 124 of the address list server system 102 or via a respective data entry computer system 114. Address codes 138 and 140 may be stored in memory 130 or secondary storage 128 during processing by the address list generator 132. Similarly, each address list 134 and 136 may be stored by the address list generator 132 in memory 130 or secondary storage 128 for delivery to the customer requesting that the respective address list 134 and 136 be generated from the source addresses 50a-50n on the source documents 60a-60n.

Although aspects of methods, systems, and articles of manufacture consistent with the present invention are depicted as being stored in memory, one having skill in the art will appreciate that these aspects may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of the data processing system 100 have been described, one skilled in the art will appreciate that a data processing system suitable for use with methods, systems, and articles of manufacture consistent with the present invention may contain additional or different components.

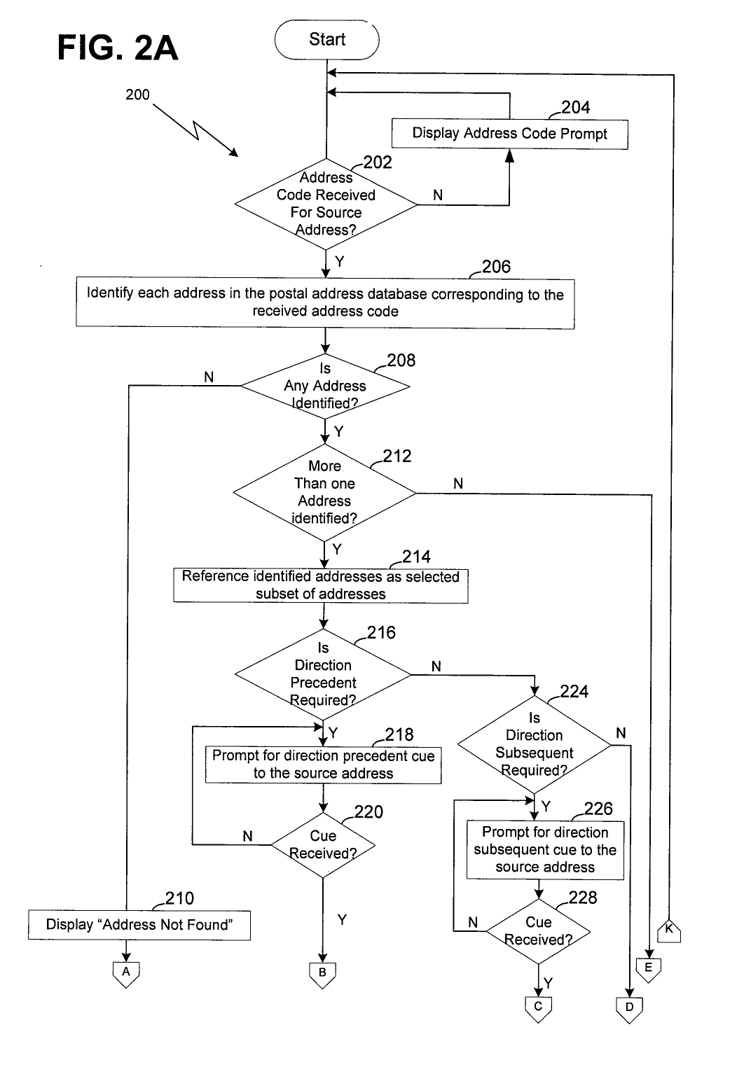

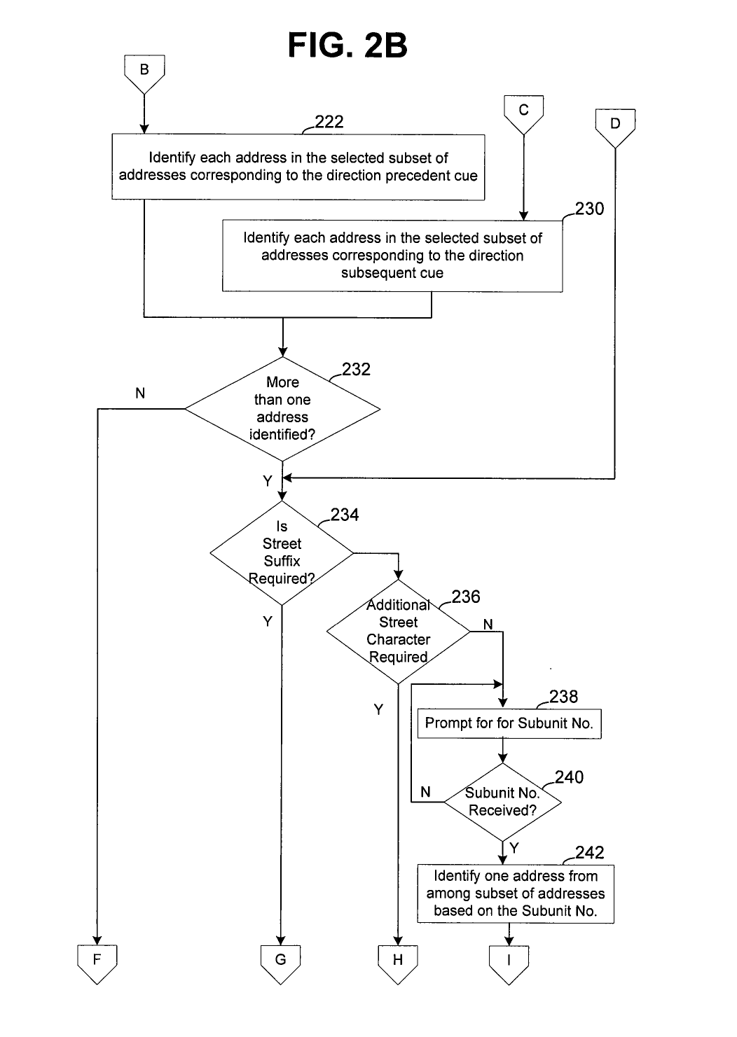

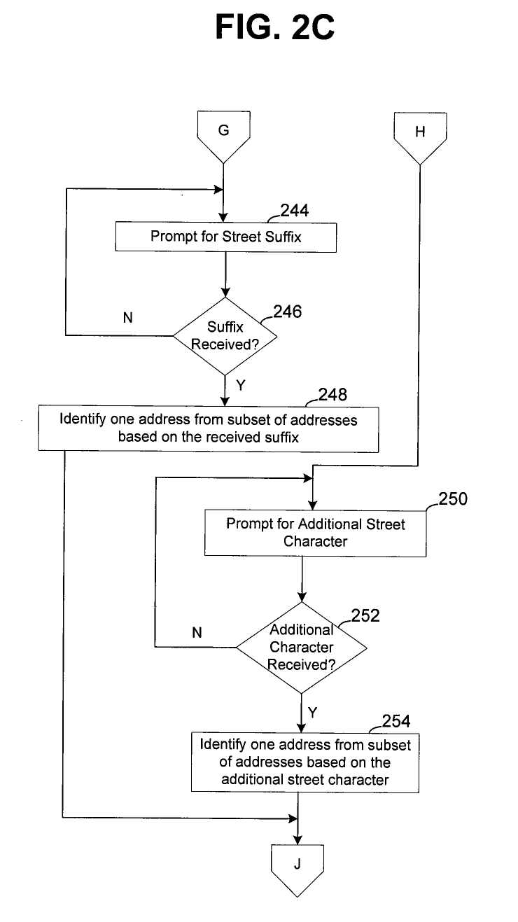

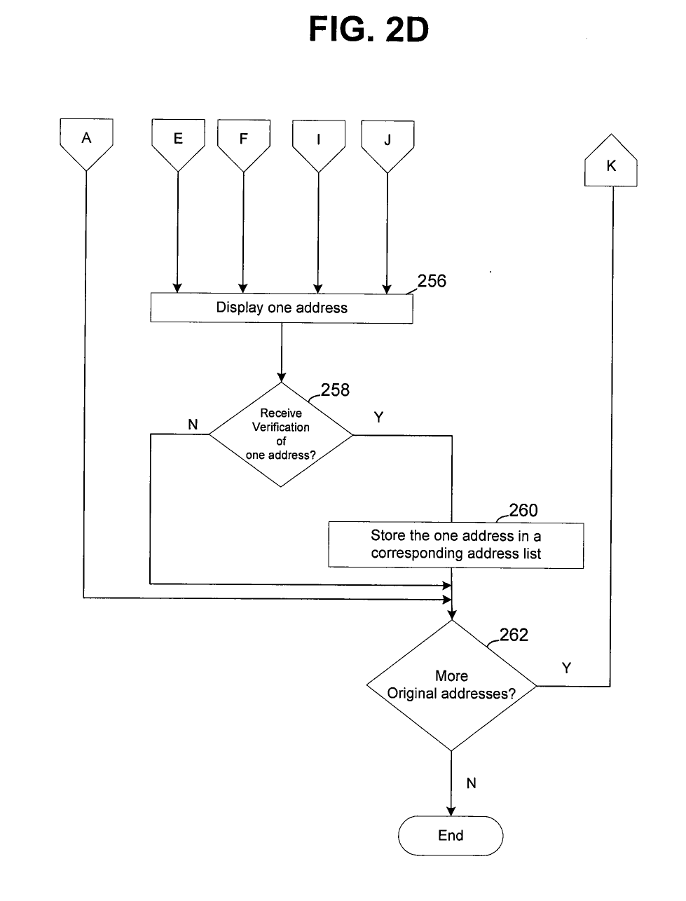

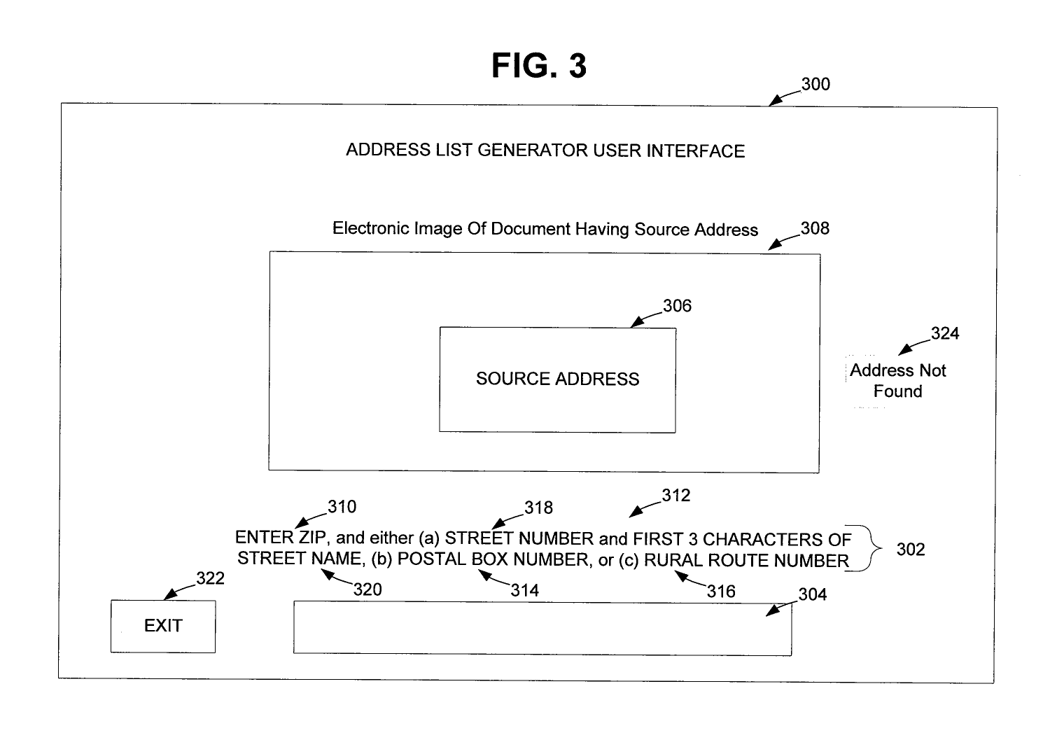

FIGS. 2A-2D depict a flow diagram illustrating an exemplary process 200 performed by the address list generator 132 to identify one of a plurality of addresses 50a-50n for an address list 134 or 136 based on an address code 138 or 140 provided by a user. Initially, the address list server system 102 determines whether an address code has been received for a source address (step 202) and, if not, displays an address code prompt (step 204) to direct a user to enter the address code for one of the source addresses 50a-50n to be included in a corresponding address list 134 or 136. In one implementation, the address list server system 102 displays a user interface 300 as shown in FIG. 3 that has a address code prompt 302 directing the user to enter an address code (e.g., 138 or 140) in a panel 304 of the user interface 300. The address code may correspond to a source address 306 of a electronic imaged document 308 displayed by the address list generator 132 on the user interface. Alternatively, the address code may correspond to a source address (e.g., 50a) of a source document (e.g., 60a) directly in view of the user.

The address code prompt 302 includes a zip code portion 310 and either a street address portion 312, a postal box number 314, or a rural route number 316, depending on the source address 50a or 306 to be entered as further explained below. In one implementation, the user enters the first five digits of the source address zip code as the zip code portion 310, although a U.S. postal zip code may currently include up to nine digits.

In one implementation, when the source address 50a-50n or 306 includes a postal box number (e.g., P.O. Box 6202), the address code provided by the user to the address list generator 132 may include a postal box number preceded or followed by a postal box identifier, such as “PO/” or other identifier, to signal to the address list generator 132 that the source address 50a-50n or 306 includes a postal box number rather than a street address (e.g., 150 Alto Mesa Street) or rural route number (Rural Route 2 Box 51). For example, assume the source address 50a or 306 corresponds to the following address: P.O. Box 6202, Metairie, La. 70009. In accordance with the present invention, a user provides to the address list generator 132 (via input panel 304) the corresponding address code of: 700096202PO/.

In one implementation, when the source address 50a-50n or 306 includes rural route number (Rural Route 2 Box 51), the address code provided by the user to the address list generator 132 may include a rural route number preceded or followed by a rural route identifier, such as “RR/” or other identifier, to signal to the address list generator 132 that the source address 50a-50n or 306 includes a rural route number rather than a street address (e.g., 150 Alto Mesa Street) or a postal box number (e.g., P.O. Box 6202). For example, assume the source address 50a or 306 corresponds to the following address: Rural Route 2 Box 51, Le Roy, Ill. 61752. In accordance with the present invention, a user provides to the address list generator 132 (via input panel 304) the corresponding address code of: 6175251RR/.

In addition, when the source address 50a-50n or 306 includes a street address (e.g., 150 Alto Mesa Street) having a street number (e.g., 150) and a street name (e.g., Alto Mesa Street) rather than a postal box number (e.g., P.O. Box 6202) or rural route number (Rural Route 2 Box 51), the user enters the street number 318 and a first portion (e.g., the first 3 characters) of the street name 320 as the street address portion 312. For example, assume the source address 50a or 306 corresponds to the following address: 150 Alto Mesa Street, El Paso, Tex. 79912. In accordance with the present invention, a user provides to the address list generator 132 (via input panel 304) the corresponding address code of: 79912150ALT.

Where the street name of the source address 50a or 306 is a number (e.g., 96^{th} street), the user may enter a delimiter (e.g., a space or backslash character) between the street number 318 and the street name 320 so that the address list generator 132 is able to distinguish the street number 318 from the street name 320 in the address code 138 or 140. In addition, the user may enter the number that constitutes the street name without the number suffix (e.g., 90 without the “th”). For example, assume the source address 50a or 306 corresponds to the following address: 90 W 96^{th} Street, Manhattan, N.Y. 10025. In accordance with the present invention, a user may provide to the address list generator 132 (via input panel 304) the corresponding address code of: 1002590 96 or 1002590/96.

When a street name 320 includes a direction precedent (e.g., north, south, east, or west) as the first word in the street name 320 (e.g., South Alto Mesa Street), the user omits the direction precedent and enters a portion (e.g., the first 3 characters) of the next word (e.g., Alto) as the first portion of the street name 320 for the address code 138 or 140. For example, assume the source address 50a or 306 corresponds to the following address: 150 South Alto Mesa Street, El Paso, Tex. 79912. In accordance with the present invention, a user provides to the address list generator 132 (via input panel 304) the corresponding address code of: 79912150ALT.

Similarly, when a street name 320 includes a direction subsequent (e.g., north, south, east, or west) as the last word or next to last word in the street name 320 (e.g., Alto Mesa West or Alto Mesa West Street), the user initially excludes the direction subsequent from the address code 50a-50n or 306 and enters a portion (e.g., the first 3 characters) of the first non-directional word as the first portion of the street name 320 for the address code. For example, assume the source address 50a or 306 corresponds to the following address: 150 Alto Mesa West, El Paso, Tex. 79912. In accordance with the present invention, a user provides to the address list generator 132 (via input panel 304) the corresponding address code of: 79912150ALT.

In addition, as further discussed below, when a street name 320 includes a street suffix (e.g., Road, Circle, Place, Avenue, Boulevard, Street, Court, or other street suffix) or a building subunit number (e.g., apartment or condo number), the user initially excludes the street suffix and subunit number from the first portion of the street name 320 for the address code.

As shown in FIG. 3, a user may indicate to the address list generator 132 that no more address codes 138 or 140 are to be entered by actuating an exit button 322 on the user interface 300.

Returning to FIG. 2A, if an address code 138 or 140 has been received, the address list generator 132 identifies each address 105a-105n in the postal address database 104 corresponding to the received address code (step 206) and, thus, determines whether any or no address 105a-105n is identified (step 208). If no address is identified, the address list generator 132 displays a message (e.g., message 324 on user interface 300) to the user reflecting that no address was found among the plurality of addresses 105a-105n in the postal address database 104 corresponding to the received address code 138 or 140 (step 210) and continues processing at step 262. In one implementation, the address list generator 132 allows the user to input the entire source address 306 for storage in a corresponding address list 134 or 136 before continuing processing at step 262.

If an address has been identified, the address list generator 132 then determines whether more than one address has been identified (step 212). If more than one address (e.g., 150a and 150n) has been identified, the address list generator 132 references the identified addresses as a selected subset of the addresses 150a-150n in the postal address database 104.

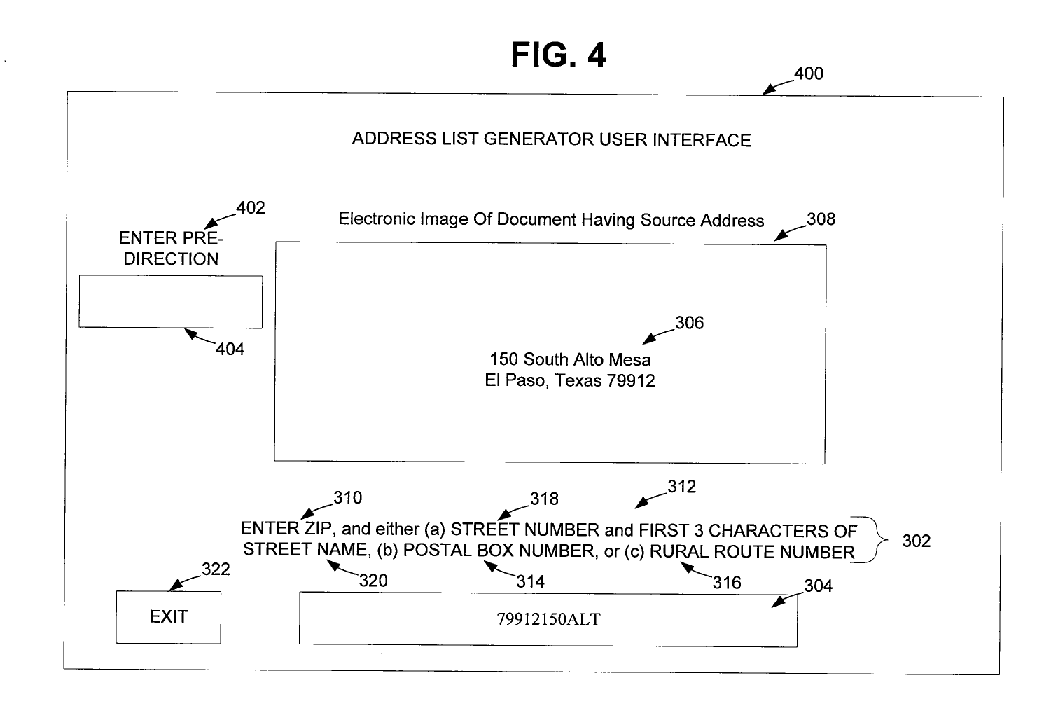

After determining that a subset of more than one address has been identified, the address list generator 132 determines whether two or more addresses in the subset differ by a direction precedent (step 216) such that a direction precedent cue is required by the address list generator 132 to identify the one address in the subset corresponding to the source address (e.g., 50a) the user is currently viewing or processing. FIG. 4 depicts an exemplary user interface 400 displayed by the address list generator 132 to prompt a user to enter a direction precedent cue corresponding to the source address 306 currently in view or being processed by the user. In the example shown in FIG. 4, the source address 306 the user is currently viewing or processing includes the following address.
150 South Alto Mesa
El Paso, Tex. 79912

In this example, the user enters “79912150ALT” as the address code corresponding to this source address 306. Continuing with this example, after initiating the process 200, the address list generator may identify a subset of the addresses 105a-105n in the postal service database 104 where the subset includes two addresses (e.g., 150 South Alto Mesa and a 150 North Alto Mesa) that differ by a direction precedent (e.g., South and North, respectively).

Recognizing the difference in direction precedent, the address list generator 132 displays a direction precedent prompt 402 on the user interface 400 to signal to the user to enter a direction precedent cue corresponding to the source address 306 (step 218). In the implementation depicted in FIG. 4, the address list generator 132 may signal to user to follow the prompt 402 by moving a cursor (not shown in FIG. 4) to an input panel 404 associated with the prompt 402. In the example implementation shown in FIG. 4, the user is thus prompted to enter an “S” in the input panel 404 as the direction precedent cue to the direction precedent of “South” in the source address 306 street name.

After displaying the direction precedent prompt 402, the address list generator 132 determines whether the direction precedent cue has been received (step 220). If the direction precedent cue has not been received, the address list generator 132 may repeat step 218 to re-prompt for a direction precedent cue. If the direction precedent cue has been received, the address list generator 132 identifies each address in the identified subset of addresses 105a-105n corresponding to the received direction precedent cue (step 222 in FIG. 2B). In the example depicted in FIG. 4, the address list generator 132 is able to discriminate or recognize the one address in the identified subset of addresses 105a-105n (e.g., the address “150 South Alto Mesa”) corresponding to the direction precedent cue of “S” received from the user. As further discussed below, when one or a single address is identified in the selected subset of addresses 105a-105n, the address list generator 132 may proceed to display the one address for user verification before storing the one address in a corresponding address list 134 or 136.

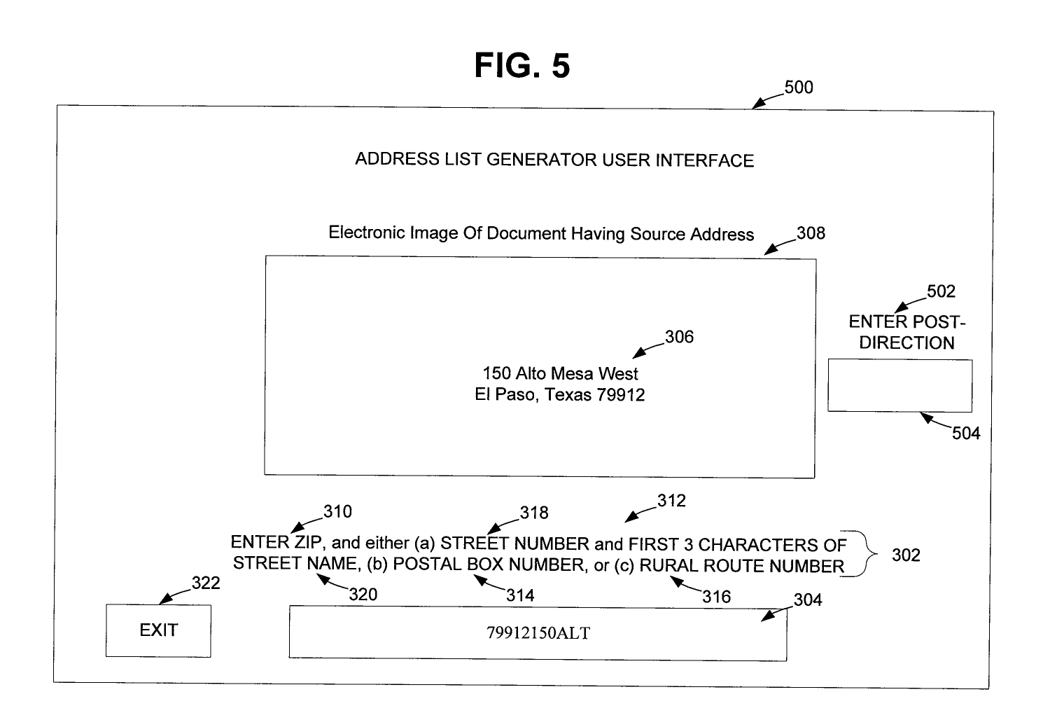

Returning to FIG. 2A, if two or more addresses in the identified subset of addresses 105a-105n do not differ by a direction precedent in step 216, the address list generator 132 determines whether two or more addresses in the identified subset of addresses 105a-105n differ by a direction subsequent (step 224). FIG. 5 depicts an exemplary user interface 500 displayed by the address list generator 132 to prompt a user to enter a direction subsequent cue corresponding to the source address 306 currently in view or being processed by the user. In the example shown in FIG. 5, the source address 306 the user is currently viewing or processing includes the following address.
150 Alto Mesa West
El Paso, Tex. 79912

In this example, the user enters “79912150ALT” as the address code corresponding to this source address 306. Continuing with this example, after initiating the process 200, the address list generator may identify a subset of the addresses 105a-105n in the postal service database 104 where the subset includes two addresses (e.g., 150 Alto Mesa West and a 150 Alto Mesa East) that differ by a direction subsequent (e.g., West and East, respectively).

Recognizing the difference in direction subsequent, the address list generator 132 displays a direction subsequent prompt 502 on the user interface 500 to signal to the user to enter a direction subsequent cue corresponding to the source address 306 (step 226). In the implementation depicted in FIG. 5, the address list generator 132 may signal to user to follow the prompt 502 by moving a cursor (not shown in FIG. 5) to an input panel 504 associated with the prompt 502. In the example implementation shown in FIG. 5, the user is thus prompted to enter a “W” in the input panel 504 as the direction subsequent cue to the direction subsequent of “West” in the source address 306 street name.

After displaying the direction subsequent prompt 502, the address list generator 132 determines whether the direction subsequent cue has been received (step 228). If the direction precedent cue has not been received, the address list generator 132 may repeat step 226 to re-prompt for a direction subsequent cue. If the direction subsequent cue has been received, the address list generator 132 identifies each address in the identified subset of addresses 105a-105n corresponding to the received direction subsequent cue (step 230 in FIG. 2B). In the example depicted in FIG. 5, the address list generator 132 is able to discriminate or recognize the one address in the identified subset of addresses 105a-105n (e.g., the address “150 Alto Mesa West”) corresponding to the direction subsequent cue of “W” received from the user. As further discussed below, when one or a single address is identified in the selected subset of addresses 105a-105n, the address list generator 132 may proceed to display the one address for user verification before storing the one address in a corresponding address list 134 or 136.

After identifying each address in the selected subset of addresses corresponding to either the direction precedent cue in step 222 or the direction subsequent cue in step 224, the address list generator 132 determines whether more than one address has been identified in the selected subset of addresses (step 232 in FIG. 2B) such that a street suffix cue may be required to further differentiate the identified addresses in the subset of addresses. In particular, if more than one address has been identified in the subset of addresses in step 232 or if the two or more addresses in the subset of addresses 105a-105n do not differ by a direction precedent in step 216 or a direction subsequent in step 224, the address list generator 132 then determines whether the two or more addresses in the identified subset of addresses 105a-105n differ by a street suffix (step 234). If the two or more addresses in the identified subset of addresses 105a-105n do not differ by a street suffix, the address list generator 132 determines whether an additional street character is required to identify the one address in the subset of addresses that corresponds to the source address currently being viewed or processed by the user (step 236).

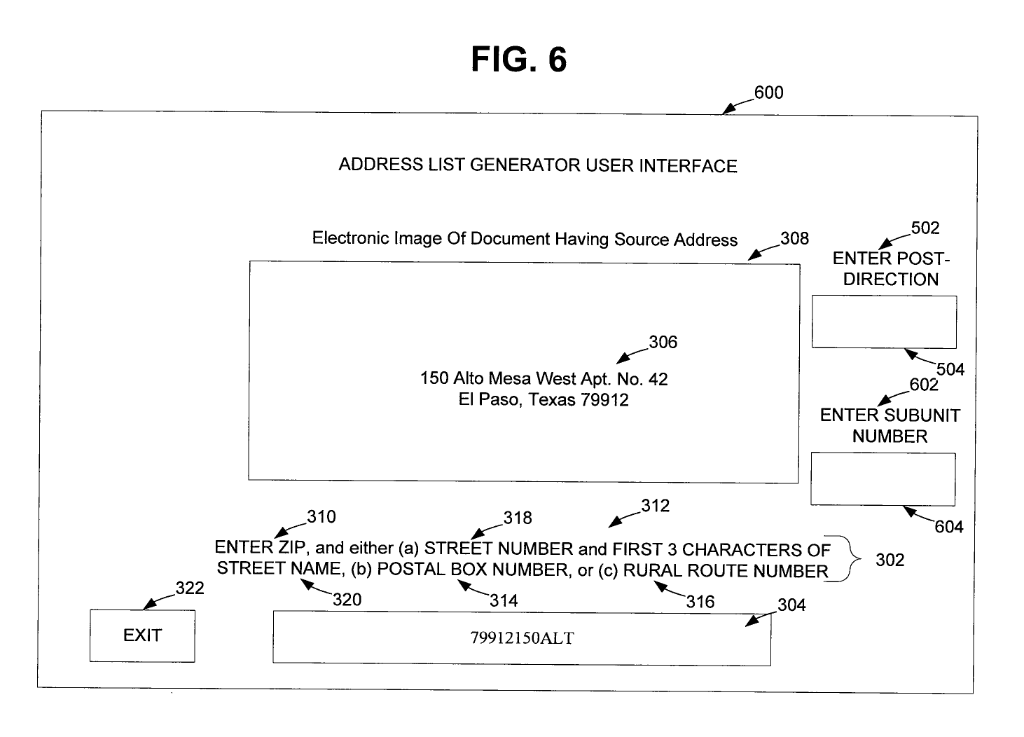

If an additional street character is not required to identify the one address, the address list generator 132 is able to recognize that the identified addresses in the subset of addresses differ by a subunit number and prompt the user for a subunit number cue (step 238). FIG. 6 depicts an exemplary user interface 600 displayed by the address list generator 132 to prompt a user to enter a subunit number cue corresponding to the source address 306 currently in view or being processed by the user. In the example shown in FIG. 6, the source address 306 the user is currently viewing or processing includes the following address.
150 Alto Mesa West Apt. No. 42
El Paso, Tex. 79912

Similar to the address code entered in the example depicted in FIG. 5, the user enters “79912150ALT” as the address code corresponding to this source address 306 in the example shown in FIG. 6. Continuing with this example, after initiating the process 200, the address list generator may identify a subset of the addresses 105a-105n in the postal service database 104 where the subset includes two addresses (e.g., 150 Alto Mesa West Apt. No. 42 and 150 Alto Mesa West Apt. No. 56) that differ by a subunit number (e.g., 42 and 56, respectively).

Recognizing the difference in the respective subunit numbers, the address list generator 132 displays a subunit number prompt 602 on the user interface 600 to signal to the user to enter a subunit number cue corresponding to the source address 306 (step 238). The subunit number cue may include one or more digits of the subunit number (e.g., “4” or “42”) associated with the source address 306. In the implementation depicted in FIG. 6, the address list generator 132 may signal to the user to follow the prompt 602 by moving a cursor (not shown in FIG. 6) to an input panel 604 associated with the prompt 602. In the example implementation shown in FIG. 6, the user is thus prompted to enter “42” or a portion of “42” in the input panel 604 as the subunit number cue for the source address 306 street name.

After displaying the subunit number prompt 602, the address list generator 132 determines whether the subunit number cue has been received (step 240). If the subunit number cue has not been received, the address list generator 132 may repeat step 238 to re-prompt for a subunit number cue. If the subunit number cue has been received, the address list generator 132 identifies one address from among the identified subset of addresses 105a-105n based on the received subunit number cue (step 242). In the example depicted in FIG. 6, the address list generator 132 is able to discriminate or recognize the one address in the identified subset of addresses 105a-105n (e.g., the address “150 Alto Mesa West Apt. No. 42”) based on the subunit number cue of “4” received from the user. As further discussed below, when one or a single address is identified in the selected subset of addresses 105a-105n, the address list generator 132 may proceed to display the one address for user verification before storing the one address in a corresponding address list 134 or 136.

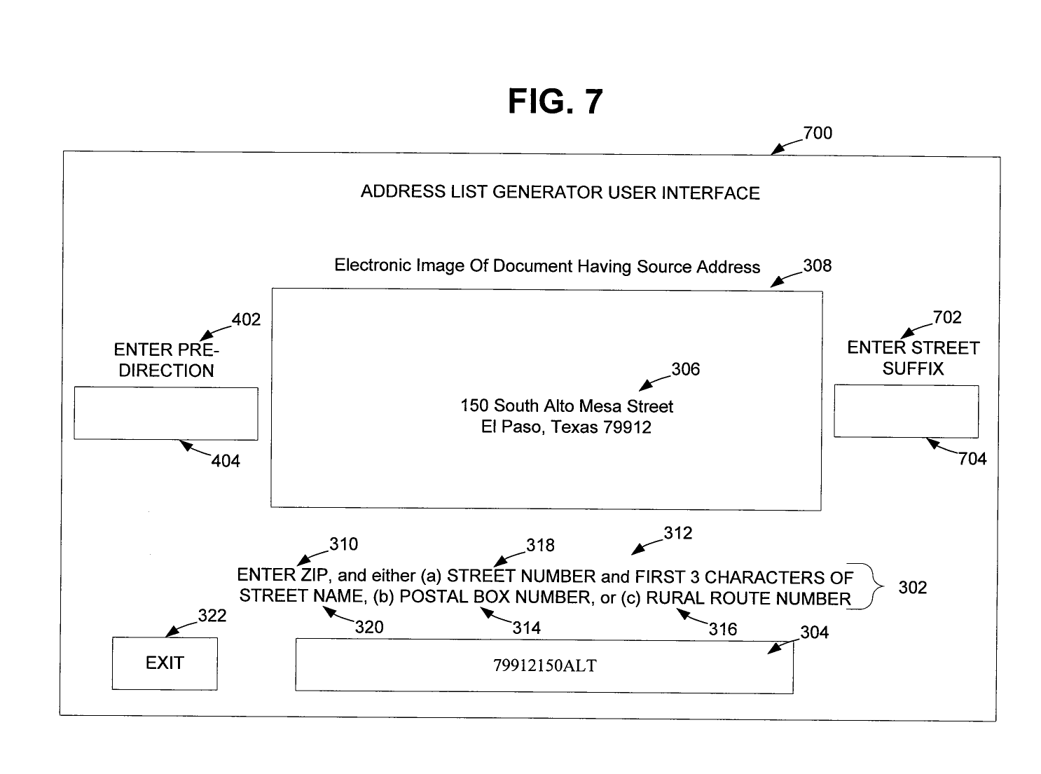

Turning to FIG. 2C, if the two or more addresses in the identified subset of addresses 105a-105n differ by a street suffix, the address list generator 132 prompts the user for a street suffix cue (step 244). FIG. 7 depicts an exemplary user interface 700 displayed by the address list generator 132 to prompt a user to enter a street suffix cue corresponding to the source address 306 currently in view or being processed by the user. In the example shown in FIG. 7, the source address 306 the user is currently viewing or processing includes the following address.
150 South Alto Mesa Street
El Paso, Tex. 79912

Similar to the address code entered in the examples depicted in FIGS. 4-6, the user enters “79912150ALT” as the address code corresponding to this source address 306 in the example shown in FIG. 7. Continuing with this example, after initiating the process 200, the address list generator may identify a subset of the addresses 105a-105n in the postal service database 104 where the subset includes two addresses (e.g., 150 Alto Mesa Street and 150 Alto Mesa Avenue) that differ by a street suffix (e.g., “Street” and “Avenue”, respectively). In one implementation, upon recognizing the difference in the respective street suffixes, the address list generator 132 displays the street suffix prompt 702 on the user interface 700 to signal to the user to enter a street suffix cue corresponding to the source address 306. The user may enter one or more characters of the street suffix associated with the source address 306. For example, if the source address 306 has a street suffix of Street, Avenue, Road, Place, Circle, or Court, the user may enter “S,” “A,” “R,” “P,” “Cir” or “Cou,” respectively. In the implementation depicted in FIG. 7, the address list generator 132 may signal to the user to follow the prompt 702 by moving a cursor (not shown in FIG. 7) to an input panel 704 associated with the prompt 702. In the example implementation shown in FIG. 7, the user is thus prompted to enter “S” in the input panel 604 as the street suffix cue for the source address 306 street name.

After displaying the street suffix prompt 702, the address list generator 132 determines whether the street suffix cue has been received (step 246). If the street suffix cue has not been received, the address list generator 132 may repeat step 244 to re-prompt for a street suffix cue. If the street suffix cue has been received, the address list generator 132 identifies one address from among the identified subset of addresses 105a-105n based on the received street suffix cue (step 248). In the example depicted in FIG. 7, the address list generator 132 is able to discriminate or recognize the one address in the identified subset of addresses 105a-105n (e.g., the address “150 South Alto Mesa Street”) based on the street suffix cue of “S” received from the user. As further discussed below, when one or a single address is identified in the selected subset of addresses 105a-105n, the address list generator 132 may proceed to display the one address for user verification before storing the one address in a corresponding address list 134 or 136.

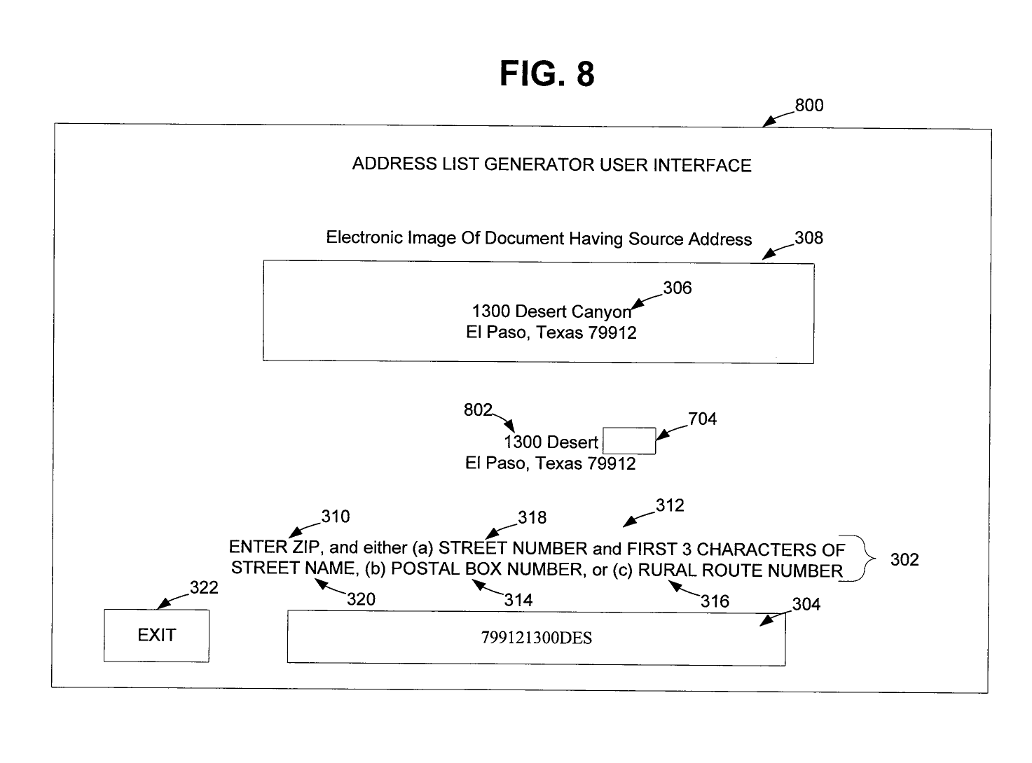

Returning to FIG. 2C, if an additional street character is required to identify the one address, the address list generator 132 prompts the user for the additional street character (step 250). FIG. 8 depicts an exemplary user interface 800 displayed by the address list generator 132 to prompt a user to enter an additional street character corresponding to the source address 306 currently in view or being processed by the user. In the example shown in FIG. 8, the source address 306 the user is currently viewing or processing includes the following address.
1300 Desert Canyon
El Paso, Tex. 79912

In this example, the user enters “79912150DES” as the address code corresponding to this source address 306 in the example shown in FIG. 8. Continuing with this example, after initiating the process 200, the address list generator may identify a subset of the addresses 105a-105n in the postal service database 104 where the subset includes two addresses (e.g., 1300 Desert Canyon and 1300 Desert Jewel) that differ by an additional word in the street name of the source address 306 (e.g., “Canyon” and “Jewel”, respectively). In one implementation, upon recognizing the difference in the respective street names, the address list generator 132 displays a partial address 702 corresponding to the current source address 306 and a prompt 704 (e.g., a cursor or other input indicator) in association with the partial address 702 to signal the user to enter an additional character of the next word in the street name of the current source code 306. In the example implementation shown in FIG. 8, the user is thus prompted to enter “C” in accordance with the prompt 704 as the additional character for the source address 306 street name. Thus, the address list generator 132 enables the user to avoid entering spaces between words or characters that may result in no identification or an inaccurate identification of the one address among the plurality of addresses 105a-105n in the postal service database 104 that corresponds to the current source address 306.

After displaying the additional street character prompt 804 in association with the partial address 802, the address list generator 132 determines whether the additional street character has been received (step 252). If the additional street character has not been received, the address list generator 132 may repeat step 250 to re-prompt for the additional street character. If the additional street character has been received, the address list generator 132 identifies one address from among the identified subset of addresses 105a-105n based on the additional street character (step 254).

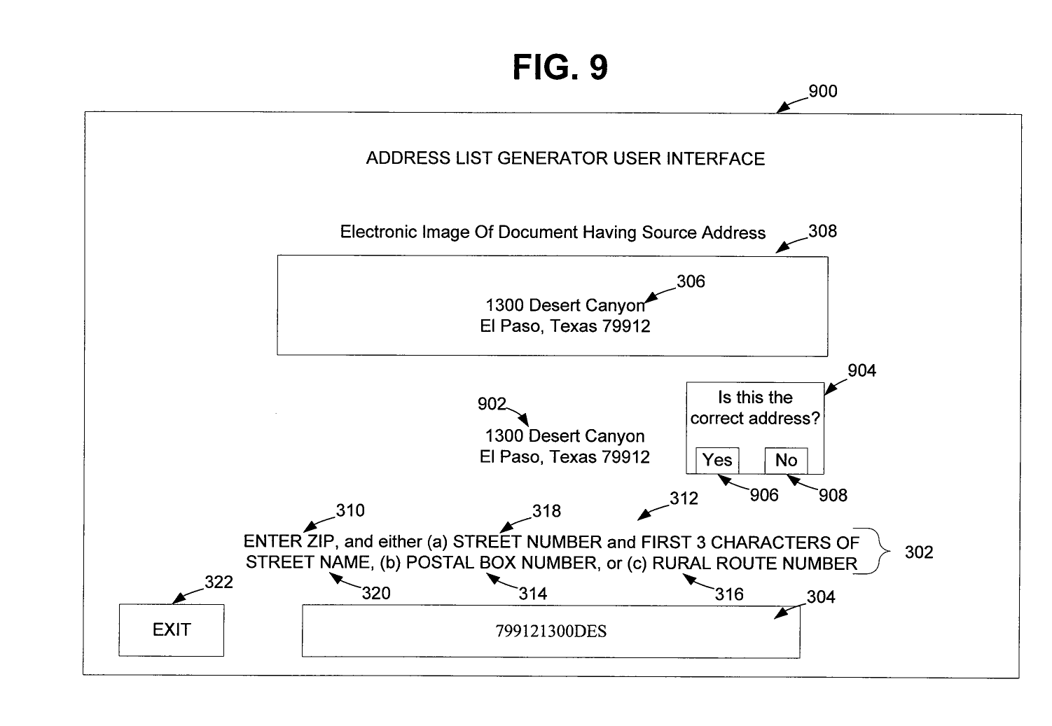

Turning to FIG. 2D, after the one address has been identified in step 212, 232, 242, or 254, the address list generator 132 displays the one address (step 256) and determines whether verification has been received that the one address corresponds to the current source code in view or being processed by the user (step 258). FIG. 9 depicts an exemplary user interface 900 displayed by the address list generator 132 to prompt the user to verify the one address identified by the address list generator 132 from among the plurality of addresses 105a-105n that corresponds to the current source address 306. As shown in FIG. 9, the address list generator 132 displays the identified one address 902 in association with the current source address 306 on the electronic image of the document 308. The identified one address 902, however, may be displayed separately on the user interface 900 when the current document 308 being process is one that was not scanned or electronically imaged but is available for the user to physically view. When the address list generator 132 displays the identified one address 902 on the user interface 900, the address list generator 132 displays the complete address as identified in the postal service database 104, which may include the entire nine digits of the zip code of the address 902.

In the implementation shown in FIG. 9, the address list generator 132 also displays a prompt 904 to signal the user to actuate a first button 906 (e.g., “Yes”) to confirm that the identified one address 902 corresponds to the current source address 306 or to actuate a second button 908 (e.g., “No”) to signal that the identified one address does not corresponds to the current source address 306. However, other input data techniques may be used to signal to the address list generator 132 whether the identified one address 902 has been verified to correspond to the current source address 306.

If verification has been received that the one address corresponds to the current source code, the address list generator 132 then stores the one address in a corresponding address list 134 or 136 (step 260). In one implementation, the user may direct the address list generator 132 to start a new address list 134 or 136 for a group of source addresses 50a-50n each time the process 200 is performed. Alternatively, the user may direct the address list generator 132 to add a group of source addresses 50a-50n to an existing address list 134 or 136 before the process 200 is performed. For example, the user may provide the address list generator 132 with a file name or database record name corresponding to the existing address list 134 or 136.

Next, the address list generator 132 determines whether there are more source addresses to process (step 262). In one implementation, the user may indicate that there are no more source addresses to process by actuating the exit button 322 on the user interface 900. Alternatively, the address list generator 132 may determine that there are no more source addresses to process when no more electronic images of source documents 60a-60n (each bearing a respective source address 50a-50n) are received from the scanner 112 or other device.

If there are more source addresses to process, the address list generator 132 then continues processing at step 202. If there are no more source addresses to process, the address list generator 132 ends processing.

Thus, the address list generator 132 is operatively configured to identify one address from among a plurality of addresses 105a-105n in a postal service database 104 based on an address code derived by a user from a source address. When the address code yields a subset of identified addresses that correspond to the same address code, the address list generator 132 is operatively configured to determine whether two or more addresses in the subset differ by either a direction precedent, a direction subsequent, a street suffix, or a subunit number so that the address list generator 132 may prompt the user for a corresponding cue to distinguish the one address corresponding to the source address from among the identified addresses in the subset. The prompts displayed by the address list generator 132 guide a user to enter a source address correctly, accurately, and expeditiously. Furthermore, the address list generator enables the user to enter fewer key strokes (thereby minimizing the chance that human error will cause an inaccurate address to be inputted) than in other conventional address identification systems, such as the Firstlogic system and the Siemens Dematic system. In addition, since fewer strokes are needed to enter an address code in accordance with the present invention as opposed to an entire address, the time required to input a source address for an address list is minimized. Moreover, the address list generator 132 allows a source address to be inputted (via an address code and corresponding prompts as described herein) by a user who does not read or understand what he or she is entering. Accordingly, the address list generator 132 allows a U.S. source address to be entered by a user who is not familiar with U.S. addresses and who does not read or understand English such that individuals residing in countries with low labor costs can be employed to enter source addresses in accordance with the present invention, enabling a corresponding address list to be prepared at a reduced price for a customer.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. Additionally, the described implementation includes software, such as validation tool 130, but the present invention may be implemented as a combination of hardware and software or in hardware alone. Note also that the implementation may vary between systems. The invention may be implemented with both object-oriented and non-object-oriented programming systems. The claims and their equivalents define the scope of the invention.

What is claimed is:

1. A method in a data processing system for generating an address list from among a plurality of addresses, the method comprising:
receiving an address code for a source address, the address code having a zip code portion and one of a street address portion, a postal box number, and a rural route number;
identifying each address in the plurality of addresses corresponding to the address code;
determining whether a subset of more than one address has been identified;
when it is determined that a subset of more than one address has been identified,
determining whether two or more addresses in the subset differ by at least one of a direction precedent, a direction subsequent, a street suffix, and a subunit number; and
when it is determined that two or more addresses in the subset differ by at least one of a direction precedent, a direction subsequent, a street suffix, and a subunit number,
prompting for a cue associated with the source address and corresponding to the at least one of the direction precedent, the direction subsequent, the street suffix, and the subunit number; and
identifying a single address from among the subset based on the cue.

2. The method of claim 1, wherein each address in the plurality of addresses is associated with a respective location by a postal service agency.

3. The method of claim 1, wherein the street address portion includes a street number associated with the source address and a first portion of a street name associated with the source address.

4. The method of claim 3, wherein the first portion of the street name has three or less characters.

5. The method of claim 1, wherein, when the address code includes a postal box number, the address code further includes a postal box identifier.

6. The method of claim 1, wherein, when the address code includes a rural route number, the address code further includes a rural route identifier.

7. The method of claim 1, when it is determined that two or more addresses in the subset differ by the direction precedent, the cue is one of a group of characters consisting of N, S, W, and E.

8. The method of claim 1, when it is determined that two or more addresses in the subset differ by the direction subsequent, the cue is one of a group of characters consisting of N, S, W, and E.

9. The method of claim 1, when it is determined that two or more addresses in the subset differ by the street suffix, the cue is at least a first character of a source street suffix associated with the source address.

10. The method of claim 1, when it is determined that two or more addresses in the subset differ by the subunit number, the cue is at least a first digit of a source subunit number associated with the source address.

11. A method in a data processing system for generating an address list from among a plurality of addresses, the method comprising:
receiving an address code for a source address, the address code having a zip code portion and one of a postal box number and a rural route number; and
identifying an address in the plurality of addresses based on the address code.

12. The method of claim 11, wherein the address code includes the postal box number and an identifier to reflect that the source address is for a postal box location.

13. The method of claim 11, wherein the address code includes the rural route number and an identifier to reflect that the source address is for a rural route location.

14. A computer-readable medium containing instructions to perform a method for generating an address list from among a plurality of addresses, the method comprising the steps of:
receiving an address code for a source address, the address code having a zip code portion and one of a street address portion, a postal box number, and a rural route number;
identifying each address in the plurality of addresses corresponding to the address code;
determining whether a subset of more than one address has been identified;
when it is determined that a subset of more than one address has been identified,
determining whether two or more addresses in the subset differ by at least one of a direction precedent, a direction subsequent, a street suffix, and a subunit number; and
when it is determined that two or more addresses in the subset differ by at least one of a direction precedent, a direction subsequent, a street suffix, and a subunit number,
prompting for a cue associated with the source address and corresponding to the at least one of the direction precedent, the direction subsequent, the street suffix, and the subunit number; and
identifying a single address from among the subset based on the cue.

15. The computer-readable medium of claim 14, wherein each address in the plurality of addresses is associated with a respective location by a postal service agency.

16. The computer-readable medium of claim 14, wherein the street address portion includes a street number associated with the source address and a first portion of a street name associated with the source address.

17. The computer-readable medium of claim 16, wherein the first portion of the street name has three or less characters.

18. The computer-readable medium of claim 14, wherein, when the address code includes a postal box number, the address code further includes a postal box identifier.

19. The computer-readable medium of claim 14, wherein, when the address code includes a rural route number, the address code further includes a rural route identifier.

20. The computer-readable medium of claim 14, when it is determined that two or more addresses in the subset differ by the direction precedent, the cue is one of a group of characters consisting of N, S, W, and E.

21. The computer-readable medium of claim 14, when it is determined that two or more addresses in the subset differ by the direction subsequent, the cue is one of a group of characters consisting of N, S, W, and E.

22. The computer-readable medium of claim 14, when it is determined that two or more addresses in the subset differ by the street suffix, the cue is at least a first character of a source street suffix associated with the source address.

23. The computer-readable medium of claim 14, when it is determined that two or more addresses in the subset differ by the subunit number, the cue is at least a first digit of a source subunit number associated with the source address.

24. A computer-readable medium in a data processing system containing instructions to perform a method for generating an address list from among a plurality of addresses, the method comprising the steps of:
receiving an address code for a source address, the address code having a zip code portion and one of a postal box number and a rural route number; and
identifying an address in the plurality of addresses based on the address code.

25. The computer-readable medium of claim 24, wherein the address code includes the postal box number and an identifier to reflect that the source address is for a postal box location.

26. The computer-readable medium of claim 24, wherein the address code includes the rural route number and an identifier to reflect that the source address is for a rural route location.

27. A data processing system, comprising:
a memory device having an address list generator program that receives an address code derived from a source address and having a zip code portion and one of a street address portion, a postal box number, and a rural route number, the address list generator further identifies each address in the plurality of addresses corresponding to the address code, determines whether a subset of more than one address has been identified, when it is determined that a subset of more than one address has been identified, determines whether two or more addresses in the subset differ by at least one of a direction precedent, a direction subsequent, a street suffix, and a subunit number, and when it is determined that two or more addresses in the subset differ by at least one of a direction precedent, a direction subsequent, a street suffix, and a subunit number, prompts for a cue associated with the source address and corresponding to the at least one of the direction precedent, the direction subsequent, the street suffix, and the subunit number, and identifies a single address from among the subset based on the cue; and
a processor that runs the address list generator program.

28. The computer-readable medium of claim 27, wherein each address in the plurality of addresses is associated with a respective location by a postal service agency.

29. The computer-readable medium of claim 27, wherein the street address portion includes a street number associated with the source address and a first portion of a street name associated with the source address.

30. The computer-readable medium of claim 29, wherein the first portion of the street name has three or less characters.

31. The computer-readable medium of claim 27, wherein, when the address code includes a postal box number, the address code further includes an identifier to reflect that the source address is for a postal box location.

32. The computer-readable medium of claim 27, wherein, when the address code includes a rural route number, the address code further includes an identifier to reflect that the source address is for a rural route location.

33. A data processing system, comprising:
a memory device having an address list generator program that receives an address code derived from a source address, the address code having a zip code portion and one of a postal box number and a rural route number, and identifies an address in the plurality of addresses based on the address code; and
a processor that runs the address list generator program.

34. A data processing system, comprising:
means for receiving an address code for a source address, the address code having a zip code portion and one of a street address portion, a postal box number, and a rural route number;
means for identifying each address in the plurality of addresses corresponding to the address code;
means for determining whether a subset of more than one address has been identified;
means for, when it is determined that a subset of more than one address has been identified, determining whether two or more addresses in the subset differ by at least one of a direction precedent, a direction subsequent, a street suffix, and a subunit number; and
means for, when it is determined that two or more addresses in the subset differ by at least one of a direction precedent, a direction subsequent, a street suffix, and a subunit number, prompting for a cue associated with the source address and corresponding to the at least one of the direction precedent, the direction subsequent, the street suffix, and the subunit number; and identifying a single address from among the subset based on the cue.

35. A data processing system, comprising:
means for receiving an address code derived from a source address, the address code having a zip code portion and one of a postal box number and a rural route number; and
means for identifying an address in the plurality of addresses based on the address code.
